(19) United States
(12) Patent Application Publication
(10) Pub. No.: US 2012/0004838 A1
(43) Pub. Date: Jan. 5, 2012

(54) SYSTEM FOR CALCULATING FUEL AMOUNT OF TRAVELLING ROUTE AND METHOD THEREOF

(75) Inventors: Tae Suk Lee, Yongin (KR); Jin Ho Ha, Seoul (KR)

(73) Assignees: KIA MOTORS CORPORATION, Seoul (KR); HYUNDAI MOTOR COMPANY, Seoul (KR)

(21) Appl. No.: 12/954,473

(22) Filed: Nov. 24, 2010

(30) Foreign Application Priority Data
Jun. 30, 2010 (KR) 10-2010-0062804

(51) Int. Cl. G06F 19/00

(52) U.S. Cl. 701/123

(57) ABSTRACT

The invention provides a system for calculating a fuel amount of a travel route that may estimate and calculate a fuel consumption amount by road sections according to a traffic situation, and a method thereof.

### CROSS-REFERENCES TO RELATED APPLICATIONS

This application claims priority to the Korean patent application number 10-2010-0062804, filed on Jun. 30, 2010, which is incorporated by reference in its entirety.

### BACKGROUND OF THE INVENTION

1. Field of the Invention

The present invention is directed to a system for calculating a fuel amount of a travel route and a method thereof.

2. Description of the Related Art

In general, a travel route guide system such as a navigation system provides route data between a starting point and a destination, according to a user request. Such a recommended route does not consider a fuel consumption amount. There is a charged or fee route (high-speed route, vehicle dedicated route, shortest route) which is geared towards guiding the vehicle on a route based on the calculated shortest time. However, due to increasing high oil prices, a driver may choose a route that has increased distance in order to consume as little fuel as possible. Accordingly, such drivers do not actually like the recommended route. Therefore, there is a need for a method for calculating a navigation route based on fuel consumption.

### SUMMARY OF THE INVENTION

The present invention has been made in view of the above problems, and provides a system for calculating a fuel amount of a travel route that may estimate and calculate a fuel consumption amount by road sections according to a traffic situation, and a method thereof.

The present invention further provides a system for calculating a fuel amount of a travel route that may calculate a fuel consumption amount by road sections in consideration of a traffic light/crossroads, a stoppage time, and a driver's driving habits, and a method thereof.

The present invention further provides a system for calculating a fuel amount of a travel route that may calculate route data composed of a combination of road sections with the least fuel consumption amount when a user requests a route with respect to a starting point and a destination, and a method thereof.

In one aspect the invention provides a system for calculating a fuel amount of a travel route, comprising: a traffic information collecting unit which identifies a traffic situation by road sections; a fuel amount calculating unit which calculates a constant speed travel fuel amount consumed when a vehicle travels by the road sections at constant speed in consideration of an estimated speed according to the traffic situation by road sections; a fuel amount compensating unit which calculates a first fuel amount by road sections according to acceleration or reduction travel caused by an estimated speed in respective road sections, and a second fuel amount according to acceleration or reduction travel caused by an estimated speed difference between neighboring road sections when the vehicle travels from a specific road section to a neighboring road section; and a control unit which compensates for the first fuel amount and the second fuel amount in the constant speed travel fuel amount to calculate a compensation fuel amount by road sections.

In one embodiment, the fuel amount compensating unit further calculates a third fuel amount caused by acceleration or reduction travel occurring according to a traffic light or crossroads provided by road sections; and a fourth fuel amount by road sections caused by a stoppage time occurring according to an estimated speed; and transfers the third and fourth fuel amounts to the control unit.

In certain embodiments, the fuel amount compensating unit further calculates a fifth fuel amount occurring according to an upward (incline slope) road provided by road sections and a fuel compensation value of a downward (decline slope) road occurring according to the incline slope road provided by road sections, and transfers the fifth fuel amount and the fuel compensation value to the control unit.

In other embodiments, the invention further comprises a driving habit calculating unit which calculates a plurality of economical drive areas using vehicle information and a speed change pattern map, which calculates and transfers a driver's driving habits based on the plurality of economical drive areas according to an accumulation rate by economical drive areas to the control unit, so that the control unit compensates for the compensation fuel amount according to the driver's driving habits.

In various embodiments, the constant speed travel fuel amount is calculated by a following Equation:

Constant speed travel fuel amount=(travel resistance of a vehicle set according to an estimated speed by road sections×travel distance by road sections)/(energy efficiency of the vehicle set according to the estimated speed by road sections);

the first fuel amount is calculated by a following Equation:

First fuel amount=(estimated acceleration set according to estimated speed of the road section×weight of the vehicle×estimated acceleration or reduction distance according to acceleration or reduction travel achieved in respective road sections)/(energy efficiency of the vehicle set according to estimated speed by road sections); and

the second fuel amount is calculated by a following Equation:

Second fuel amount=(estimated acceleration by road sections set according to estimated speed between neighboring road sections×weight of the vehicle×estimated acceleration or reduction distance according to acceleration or reduction travel occurring due to movement by road sections)/(energy efficiency of the vehicle set according to estimated speed by road sections).

In other embodiments, the third fuel amount is calculated by a following Equation:

Third fuel amount={(set acceleration×weight of the vehicle×accelerated distance until the vehicle reaches an estimated speed by road sections after stop according to the number of traffic lights or crossroads located in respective road section)/(energy efficiency of the vehicle set according to estimated speed by road sections)}×stagnation probability of the vehicle at a traffic light or crossroads(%); and

the fourth fuel amount is calculated by a following Equation:

Fourth fuel amount=(stoppage time set according to estimated speed by road sections×fuel consumption amount per stoppage time).

In another embodiment, the fifth fuel amount according to the incline slope road is calculated by a following Equation:

Fifth fuel amount=(weight of vehicle×gravity acceleration×sin(road gradient)×distance of decline slope road section)/(energy efficiency of vehicle set according to estimated speed by road sections); and

when an estimated speed by road sections in a decline slope road section by the road sections is greater than a minimum vehicle speed set in the decline slope road, the fuel compensation value of the decline slope road is calculated to process that there is no constant speed travel fuel amount in the decline slope road section.

In another embodiment, the invention provides a system for calculating a fuel amount of a travel route further comprising: a map database storing map data by road sections; a route guide unit selecting route data comprising a combination of road sections with a least compensation fuel consumption amount between a starting point and a destination using the map data when receiving a request of a route guide with the starting point and the destination; and a display unit displaying the selected route data and a compensation fuel amount consumed according to the route data.

In one embodiment, the route guide unit again selects the route data composed of a combination of road sections with the least compensation fuel consumption amount between the starting point and the destination each time the vehicle enters a set crossroads during travel according to the route data.

In another embodiment, the route guide unit again selects the route data composed of a combination of road sections with the least compensation fuel consumption amount between the starting point and the destination each time the vehicle enters a main set point during travel according to the route data.

In another aspect, the invention provides a method for calculating a fuel amount of a travel route, comprising: (a) identifying a traffic situation by road sections; (b) calculating a constant speed travel fuel amount consumed when a vehicle travels by the road sections at constant speed in consideration of an estimated speed according to the traffic situation by road sections; (c) calculating a first fuel amount by road sections caused by acceleration or reduction travel occurring according to the estimated speed in respective road sections; (c-1) calculating a second fuel amount caused by acceleration or reduction travel occurring due to an estimated speed difference between neighboring road sections when the vehicle travels from a specific road section to a neighboring road section; and (d) compensating for the first fuel amount and the second fuel amount in the constant speed travel fuel amount to calculate a compensation fuel amount by road sections.

In another embodiment, the invention provides the method described above further comprising: (e) calculating a third fuel amount caused by the acceleration or reduction travel occurring according to a traffic light or crossroads provided by road sections; and (f) calculating a fourth fuel amount by road sections according to a stoppage time occurring according to an estimated speed.

In another embodiment, the invention provides a method further comprising: (g) calculating a fifth fuel amount occurring according to an incline slope road provided by road sections; (h) calculating a fuel compensation value of a decline slope road occurring according to the incline slope road provided by road sections.

In another embodiment, the invention provides a method further comprising: (i) calculating a plurality of economical drive areas using vehicle information and a speed change pattern map; and (j) calculating and transferring a driver's driving habits based on the plurality of economical drive areas according to an accumulation rate by economical drive areas to the control unit, so that the control unit compensates for the compensation fuel amount according to the driver's driving habits.

In another embodiment, the invention provides a method further comprising: (k) selecting route data comprising a combination of road sections with a least compensation fuel consumption amount between a starting point and a destination using the map data when receiving a request of a route guide with the starting point and the destination; and (l) displaying the selected route data and a compensation fuel amount consumed according to the route data.

The system for calculating a fuel amount of a travel route of the present invention compensates for a first fuel amount additionally consumed due to stagnation in a road section and a second fuel amount occurring due to an estimation speed difference between neighboring road sections in a constant speed travel fuel amount consumed when a vehicle travels by road sections at constant speed in consideration of an estimation speed according to a current traffic situation by road sections. Accordingly, the present invention provides an effect capable of accurately estimating a fuel amount in consideration of an additional fuel consumption amount according to acceleration or reduction speed due to a current traffic situation by road sections, stagnation of a vehicle according to the traffic situation, and a speed difference between road sections.

Also, the system for calculating a fuel amount of a travel route of the present invention further calculates a third fuel amount according to acceleration or reduction travel occurring according to a traffic light or crossroads; and a fourth fuel amount by road sections according to a stoppage time occurring due to an estimated speed. Accordingly, the present invention provides an effect capable of estimating an exact fuel amount considering waiting signal of a vehicle, and passing and stoppage times of crossroads.

Moreover, the system for calculating a fuel amount of a travel route of the present invention compensates for the compensation fuel amount according to a driver' driving habits. Since the present invention can consider a discrimination standard by drivers such as a driver's driving habits as well as a common fuel consumption standard of drivers such as the constant speed travel fuel amount, first to fourth fuel amounts, it may accurately estimate a fuel amount.

In addition, the system for calculating a fuel amount of a travel route of the present invention calculates route data between a starting point and a destination using map data as a combination of road sections with the least fuel consumption amount when receiving a request of a route guide with respect to the starting point and the destination. Accordingly, the present invention provides an effect that allows a user to receive route data with the least fuel consumption amount.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a system for calculating a fuel amount of a travel route according to an embodiment of the present invention;

FIG. 2 is a graph illustrating the relationship between vehicle speed and a distance during a constant speed travel of a vehicle according to an embodiment of the present invention;

FIG. 3 is a view illustrating a configuration of a road section according to an embodiment of the present invention;

FIG. 4 is a graph illustrating the relationship between vehicle speed and a distance during an acceleration or reduction travel in a road section according to an embodiment of the present invention;

FIG. 5 is a graph illustrating the relationship between vehicle speed and a distance during acceleration or reduction travel between neighboring road sections according to an embodiment of the present invention;

FIG. 6 is a graph illustrating the relationship between vehicle speed and a distance during a stop of a vehicle in a road section according to an embodiment of the present invention;

FIG. 7 is a view illustrating a captured screen of a fuel saving route displayed on a display unit according to an embodiment of the present invention; and

FIG. 8 is a flowchart illustrating a method for calculating a fuel amount of a traveling route according to an embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the present invention, a plurality of road sections are provided to be classified by sections according to a predetermined basis. To classify the road sections by sections according to a predetermined basis the respective road sections are classified based on large crossroads or in units of a predetermined distance, for example, 1 km. The respective road sections can be classified based on a name of a road section such as East Main street, North Main street, Olympic road, etc. The respective road section of the present invention can be classified by grouping continuous road sections with similar traffic flow according to a user setting. The road section of the present invention can be classified by grouping road sections belonging to a unit of city, state, province, or district.

—Description of All Configurations—

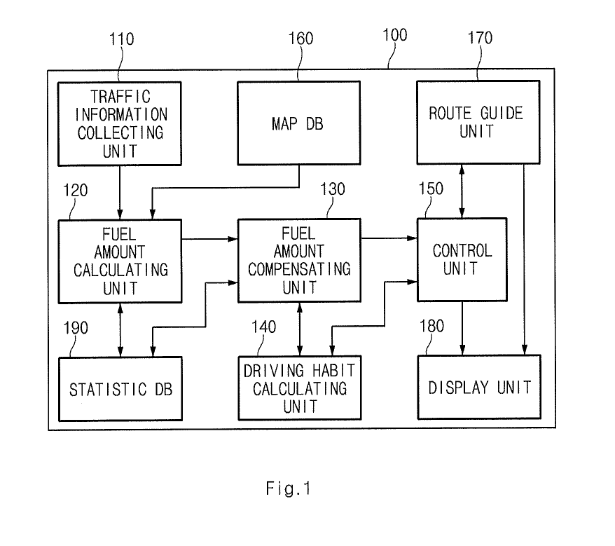

FIG. 1 is a block diagram illustrating a configuration of a system 100 for calculating a fuel amount of a traveling route according to an embodiment of the present invention.

Referring to FIG. 1, the system 100 for calculating a fuel amount of a travel route according to an embodiment of the present invention comprises a traffic information collecting unit 110, a fuel amount calculating unit 120, a fuel amount compensating unit 130, a driving habit calculating unit 140, a control unit 150, a map database 160, a route guide unit 170, and a display unit 180.

The traffic information collecting unit 110 collects traffic information by road sections. The fuel amount calculating unit 120 calculates a constant travel fuel amount consumed when a vehicle travels at constant speed by road sections using the traffic information by road sections.

The fuel amount compensating unit 130 calculate a first additional fuel amount according to stagnation occurring in a road section from the constant travel fuel amount. The fuel amount compensating unit 130 calculates a second additional fuel amount according to a difference between estimated speeds between neighboring road sections. The fuel amount compensating unit 130 calculates a third fuel amount according to a traffic light and crossroads. The fuel amount compensating unit 130 calculates a fourth fuel amount according to a stoppage time of a vehicle.

The driving habit calculating unit 140 notes a driver's driving habits into a database. The control unit 150 compensates for the constant travel fuel amount using a first fuel amount to a fourth fuel amount and the driver's driving habits.

In the meantime, the route guide unit 170 receives a request of a route guide with respect to a starting point and a destination. Further, the route guide unit 170 provides route data including a combination of road sections consuming the least fuel amount to a driver through a display unit 180.

Hereinafter, the system 100 for calculating a fuel amount of a traveling route will be described in detail by structural elements.

—Collection of Traffic Information—

Referring to FIG. 1, the traffic information collecting unit 110 receives traffic information by road sections from a separate traffic information collecting center (not shown) to estimate current speed by road sections.

—Calculation of Constant Speed Travel Fuel Amount Consumed During Constant Speed Travel by Road Sections—

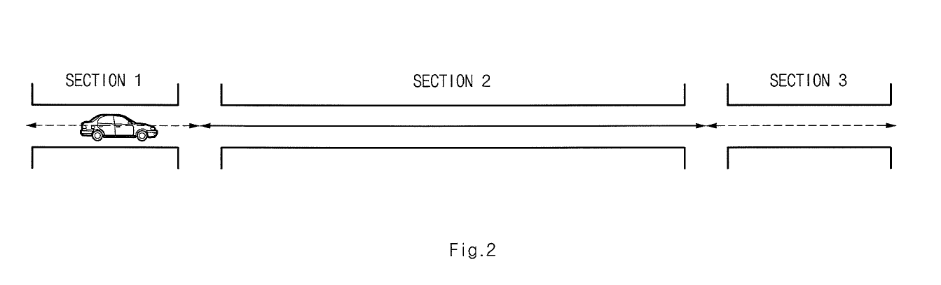

FIG. 2 is a graph illustrating the relationship between vehicle speed and a distance during a constant speed of travel of a vehicle according to an embodiment of the present invention.

Referring to FIG. 1 and FIG. 2, the fuel amount calculating unit 120 calculates a constant speed travel fuel amount consumed when a vehicle travels by road sections at constant speed using the current estimated speed by road sections and a distance value by road sections of map data stored in a map database 160 to be described below. The constant speed fuel amount is defined as a fuel amount occurring when a vehicle normally travels by road sections without unexpected situations such as stagnation. The constant speed travel fuel amount can be calculated by a following Equation 1.

$$Constant speed travel fueal amount = \frac{Energy}{Energy efficiency}$$

In Equation 1, the energy (J)=travel resistance of a vehicle set according to an estimated speed by road sections×travel distance by road sections, and the energy efficiency (J/ml) is energy efficiency of the vehicle set according to the estimated speed by road sections. The travel resistance of the vehicle is resistance occurring when the vehicle travels, and can be differently set according to estimated speeds and weights of the vehicles. The energy efficiency is calculated by a road section based on an experimentally statistic value of a fuel consumption amount obtained by travelling the vehicle in a real road section according to the estimated speed (RPM) and an estimated acceleration of the vehicle. For example, a fuel amount occurring when a driver drives the vehicle at constant speed by various speeds and accelerations in a specific road section are identified through an experiment, and the energy efficiency is calculated through correlation between the grasped speed/acceleration and fuel amount of the vehicle.

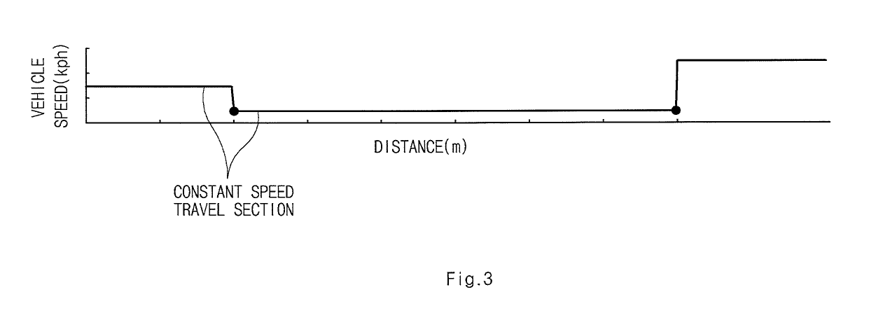

FIG. 3 is a view illustrating a configuration of a road section according to an embodiment of the present invention.

Referring to FIG. 3, it is assumed that there is a first road section to a third road section, an estimated speed and a travelling distance of a first road section are 40 km/h and 300 m according to a current traffic situation, estimated speed and a travelling distance of a second road section are 60 km/h and 500 m according to a current traffic situation, and estimated speed and a travelling distance of a third road section are 50 km/h and 200 m according to a current traffic situation.

In this case, respective energies (J) of the first road section to the third road section are multiplying values of travel resistances of a vehicle set according to estimated speeds 40 km/h, 60 km/h, and 50 km/h thereof, and travel distances 300 m, 500 m, and 200 m by road sections. The energy efficiency (J/ml) can be grasped through experimentally statistic values of fuel consumption amounts set according to the estimated speeds 40 km/h, 60 km/h, and 50 km/h of the first road section to the third road section.

—Calculation of First Fuel Amount According to Acceleration and Reduction Travels in a Road Section—

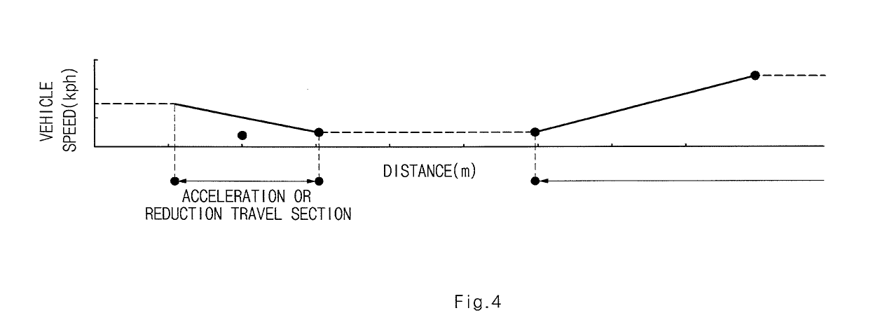

FIG. 4 is a graph illustrating relationship between vehicle speed and a distance during acceleration or reduction travel in a road section according to an embodiment of the present invention.

Referring to FIG. 1 and FIG. 4, a fuel amount compensating unit 130 calculates a first fuel amount by road sections due to acceleration or reduction travel generated according to the estimated speed in respective road sections. Here, the first fuel amount is defined as a fuel amount occurring at the time of additionally consuming a fuel due to stagnation in respective road sections in comparison with constant speed of travel of a vehicle. For example, when the estimated speed of the first road section is 40 km/h and a distance of a specific road section is 300 m, acceleration or reduction travel can occur due to stagnation in a section of 60 m corresponding to acceleration or reduction section rate of 20%. Further, when the estimated speed of the second road section is 60 km/h and a distance of a specific road section is 500 m, acceleration or reduction travel can occur due to stagnation in a section of 25 m corresponding to acceleration or reduction section rate of, for example, 5%.

The acceleration or reduction section rate of 5% or 20% is stored in a statistic database 190 based on experimentally statistic values (using a travel vehicle speed profile and accelerator operation profile through real travel). Accordingly, the fuel amount compensating unit 130 identifies the acceleration or reduction section rate by referring the statistic database 190. Furthermore, the fuel amount compensating unit 130 should identify estimated acceleration by road sections for a vehicle travelling at an acceleration or reduction distance according to the acceleration or reduction section rate at acceleration or reduction speed. Estimated acceleration by road sections according to the estimated speed of the road section (estimated acceleration of 1.0 m/s² when the estimated speed is 50 km/h) is stored in the statistic database 190 by an experimentally statistic value according to the estimated speed of the road section. The reason to apply acceleration to the first fuel amount and the second fuel amount/third fuel amount to be described below is that the first fuel amount/the second fuel amount/the third fuel amount are not a fuel amount like a constant speed travel fuel amount for constant speed travel at an estimated speed, but a fuel amount for acceleration or reduction travel.

The first fuel amount is calculated by a following Equation 2.

[Equation 29]

First fuel amount=(estimated acceleration set according to an estimated speed of the road section×weight of the vehicle×estimated acceleration or reduction distance according to acceleration or reduction travel achieved in respective road sections)/(energy efficiency of the vehicle set according to estimated speed by road sections)

Calculation of Second Fuel Amount According to Acceleration or Reduction Travel Between Neighboring Road Sections

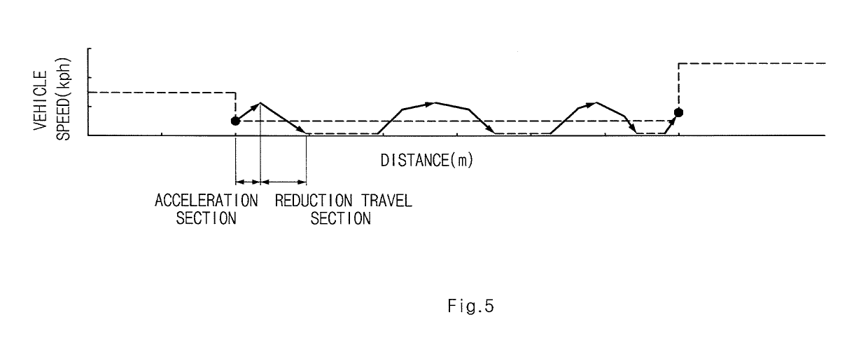

FIG. 5 is a graph illustrating the relationship between vehicle speed and a distance during acceleration or reduction travel between neighboring road sections according to an embodiment of the present invention.

Referring to FIG. 1 and FIG. 5, the fuel amount compensating unit 130 calculates a second fuel amount due to acceleration or reduction travel achieved according to a difference between estimated speeds of neighboring road sections when a vehicle travels from a specific road section to a neighboring road section.

For example, it is assumed that there are a first road section to a third road section, the estimated speed and a travelling distance of a first road section are 40 km/h and 300 m according to a current traffic situation, and estimated speed and a travelling distance of a second road section are 60 km/h and 500 m according to a current traffic situation. In this case, after terminating travel of a first road section, when the vehicle enters a second road section, acceleration or reduction travel can occur due to an estimated speed difference between the first road section and the second road section. For example, when the estimated speed difference between the first road section and the second road section is 20 km/h, the acceleration or reduction travel can occur by a distance corresponding to 10% (acceleration or reduction speed rate) of an entire distance of the second road section (entire distance of the first and second road sections).

Meanwhile, when the estimated speed difference between the first road section and the second road section is 40 km/h, the acceleration or reduction travel can occur by a distance corresponding to 40% (acceleration or reduction speed rate) of an entire distance of the second road section. The acceleration or reduction speed rate of 10% or 40%, according to an estimated speed difference between neighboring road sections, is stored in a statistic database 190 based on an experimentally statistic value. The fuel amount compensating unit 130 identifies a rate of an occurring distance of acceleration or reduction travel according to the estimated speed difference between neighboring road sections by referring to the statistic database 190. Further, the fuel amount compensating unit 130 should identify estimated acceleration by road sections to travel the vehicle by occurring distance of acceleration or reduction travel at acceleration or reduction speed according to the estimated speed difference. The estimated acceleration by road sections according to an estimated speed of the road section is stored in the statistic database 190 based on experimentally statistic value according to an estimated speed of the road section. In this case, for example, when the estimated speed difference is 40 km/h, the estimated acceleration is 2.0 m/s².

The second fuel amount is calculated by a following Equation 3.

[Equation 3]

Second fuel amount=(estimated acceleration by road sections set according to estimated speed between neighboring road sections×weight of the vehicle×estimated acceleration or reduction distance according to acceleration or reduction travel occurring due to movement by road sections)/(energy efficiency of the vehicle set according to estimated speed by road sections)

Here, since the first fuel amount and third fuel amount/fourth fuel amount to be described below are consumed in respective road sections, they are calculated by road sections, and the second fuel amount is calculated by a pair of neighboring road sections.

—Calculation of Third Fuel Amount According to Traffic Light or Crossroads Located by Road Sections and Fourth Fuel Amount According to Stoppage Time—

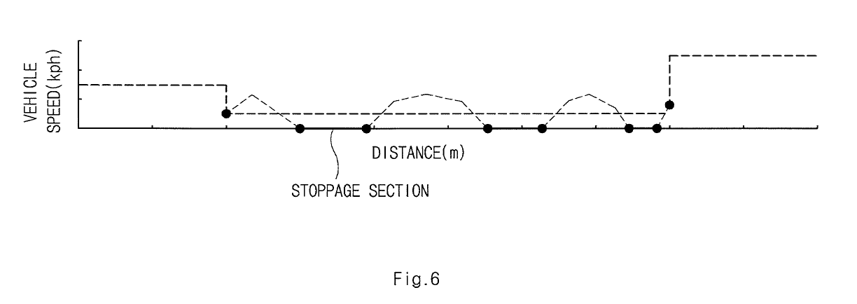

FIG. 6 is a graph illustrating the relationship between vehicle speed and a distance during a stop of a vehicle in a road section according to an y embodiment of the present invention.

Meanwhile, the fuel amount compensating unit 130 further calculates a third fuel amount according to acceleration or reduction travel occurring according to a traffic light or crossroads located by road sections. The third fuel amount is calculated by a following Equation 4.

[Equation 4]

Third fuel amount={(set acceleration×weight of the vehicle×accelerated distance until the vehicle reaches an estimated speed by road sections after stop according to the number of traffic lights or crossroads located in respective road section)/(energy efficiency of the vehicle set according to an estimated speed by road sections)}×stagnation probability of the vehicle at traffic light or crossroads(%)

Here, unlike the estimated acceleration of the Equation 3, the set acceleration is not estimated acceleration set according to estimated speed of the road section, but is acceleration accelerating to the estimated speed by road sections in a stop state. Consequently, the set acceleration is set to, for example, 2.0 m/s² irrespective of the estimated speed. In the meantime, when the estimated acceleration is 2.0 m/s² and the estimated speed is 50 km/h, because vehicle speed in a stopped state is 0 km/h, according to uniformly accelerated motion Equation, an accelerated distance until the vehicle reaches an estimated speed by road sections after stop in respective road section occurs according to a traffic light or crossroads, namely, S={(estimated speed)²−V1(stop speed)²}/2a(estimated acceleration)={50²−0²}/(2×2)=625 m. When two crossroads or traffic lights are located in a corresponding road section, the accelerated distance S=625 m×2=1250 m. Meanwhile, the stop probability of the vehicle at a traffic light or crossroads(%) does not indicate that the vehicle unconditionally stops at the traffic light or crossroads. For example, when a green light of the traffic light is turned on, because the vehicle can pass through the traffic light without stopping, The stop probability of the vehicle is set to, for example, 30% (0.30) based on the experimentally statistic value.

Meanwhile, the fuel amount compensating unit 130 further calculates a fourth fuel amount according to a stoppage time occurring according to an estimated speed by road sections. The fourth fuel amount is calculated by a following Equation 5.

[Equation 5]

Fourth fuel amount=(stoppage time set according to an estimated speed by road sections×fuel consumption amount per stoppage time)

Here, the stoppage time set according to an estimated speed by road sections is a stoppage time calculated by estimated speeds based on an experimentally statistic value, and the fuel consumption amount per stoppage time is defined as a fuel amount calculated based on the experimentally statistic value according to the stoppage time.

The control unit 150 compensates the first fuel amount, the third fuel amount, and the fourth fuel amount of the fuel amount to calculate a compensated fuel amount by road sections.

—Calculation of Fifth Fuel Amount and Fuel Compensation Value of Downward Road According to an Incline Slope Road and the Decline Slope Road Provided by Road Sections—

In the meantime, the fuel amount compensating unit 130 further calculates a fifth fuel amount according to a travel distance occurring according to an incline slope road or a decline slope road provided at respective road sections. Here, the incline slope road is defined as a section in the road section having a gradient larger than a minimum gradient set differently by vehicles. For example, when the minimum gradient is set to three and a section in a specific road section having a gradient higher than 3 is 150 m, the incline slope road is set to 150 m. Incline slope road data are stored in a map database 160. The fifth fuel amount according to the incline slope road is calculated by a following Equation 6.

[Equation 6]

Fifth fuel amount=(weight of vehicle×gravity acceleration×sin(road gradient)×distance of decline slope road section)/(energy efficiency of vehicle set according to an estimated speed by road sections)

Here, the stoppage time set according to an estimated speed by road sections is a stoppage time calculated by estimated speeds based on an experimentally statistic value, and the fuel consumption amount per stoppage time means a fuel amount calculated based on the experimentally statistic value according to the stoppage time.

The control unit 150 compensates for the first fuel amount, the second fuel amount, the third fuel amount, the fourth fuel amount, and the fifth fuel amount of the constant speed travel fuel amount to obtain a compensated fuel amount by road sections.

Meanwhile, the decline slope road refers to a section having a gradient smaller than a minimum gradient set differently by vehicles in the road section. For example, when the minimum gradient is set to three and a section in a specific road section having a gradient higher than 3 is 100 m, the incline slope road is set to 100 m. Incline slope road data are stored in a map database 160. When an estimated speed by road sections in a decline slope road section by road sections is greater than a minimum vehicle speed set in the decline slope road, the fuel amount compensating unit 130 calculates a fuel compensation value of a decline slope road indicating that a constant speed travel fuel amount in the decline slope road section is processed to zero.

That is, the control unit 150 compensates the first fuel amount, the second fuel amount, the third fuel amount, the fourth fuel amount, the fifth fuel amount, and the fuel compensation value from a decline slope road of the constant speed travel fuel amount to obtain a compensated fuel amount by road sections.

—Compensation of Fuel Amount According to a Driver's Driving Habits—

The driving habit calculating unit 140 calculates economical drive areas using vehicle information. Further, the driving habit calculating unit 140 calculates a driver's driving habits according to an accumulation rate by areas among the calculated economical drive areas. The driving habit calculating unit 140 includes a vehicle information collector and a calculator.

The vehicle information collector collects vehicle speed information, engine torque information, a throttle position sensor (TPS) value, speed change pattern data, and vehicle information such as on/off of a current change gear and a damper clutch from an engine controller (not shown), a speech change controller (not shown), and a vehicle controller (not show) through a vehicle network.

In this case, the vehicle information collector collects the vehicle speed and the TPS value from the engine controller, and the speed change pattern data and the on/off of a current change gear and a damper clutch from the speed change controller. The foregoing information can be directly acquired from a vehicle speed sensor or a TPS instead of the engine controller and the speed change controller.

The calculator calculates a current travel state and economical drive area using vehicle information and a speed change pattern map, accumulates the economical drive area for a predetermined time, and calculates a rate of the accumulated economical drive areas. In this case, the economical drive areas are divided into the largest economical drive area (green area), a middle economical drive area (white area), and the smallest economical drive area (red area).

In detail, when the vehicle has speed of 0˜15 km/h in an oscillation mode, the calculator determines a green area when TPS is 1˜A%, determines a white area when the TPS is 0% or A˜B%, and determines a green area when the TPS is B˜100%.

Further, when the vehicle has speed of 16˜70 km/h in an oscillation mode, the calculator determines a green area when TPS is 1˜A%. The calculator determines a white area when the TPS is 0% or A′˜B′%, and determines a red area when the TPS is B′˜100%. Meanwhile, the calculator determines all cases as a green area in a speed reduction mode (speed reduction mode during oscillation or travel). The calculation stores the calculated economical drive area information to accumulate a time driving at a green area, a time driving at a white area, and a time driving at a red area by the driver. Moreover, the calculator calculates an accumulation rate of a time driving at a green area, a time driving at a white area, and a time driving at a red area by the driver to store a driver's time by areas in a separate storage unit. Here, the A and B are previously designated based on the experimentally statistic value.

Meanwhile, the control unit 150 compensates for the compensation fuel amount according to the driver's time by areas stored in the separate storage unit. When a driver's driving habits are excellent (when rate of green area/white area is relatively high), the control unit 150 compensates for a compensation fuel amount to reduce the compensation fuel amount (e.g., reduction of 10%). Conversely, when a driver's driving habits are bad (when a rate of a red area is relatively high), the control unit 150 compensates for a compensation fuel amount to reduce the compensation fuel amount (e.g., increase of 10%).

—Guide of Fuel Saving Route—

The map database 160 stores map data by road sections including a travel distance by road sections, position information, identification information, and guide information of a road section.

The route guide unit 170 receives a request of a route guide with respect to a starting point and a destination from a driver through a separate key input unit (not shown) or an external navigation terminal device (not shown). Furthermore, the route guide unit 170 calculates a plurality of route data using map data in a general method (shortest route (fast route), high-speed route, recommended route, free route, and pay route) between a starting point and a destination. In addition, the route guide unit 170 selects route data composed of a combination of road sections with the least compensation fuel consumption amount among the plurality of calculated route data.

Another embodiment of the route guide unit 170 again selects route data composed of a combination of road sections with the least compensation fuel consumption amount with respect to a remaining distance from crossroads to a destination each time the driver enters the crossroads while traveling the route data, for example, every a position of 3 km spaced from an entry thereof. Namely, after the driver receives a request of a route guide with respect to the starting point and the destination, a traffic situation of a road section can be continuously changed. Accordingly, each time the vehicle enters set crossroads during travel, the route guide unit 170 again selects route data every a position of 30 km spaced from the crossroads. As a result, the driver can also receive provision of route data composed of a combination of road sections with the least compensation fuel consumption amount in a changed traffic situation.

A further embodiment of the route guide unit 170 again selects route data composed of a combination of road sections with the least compensation fuel consumption amount with respect to a remaining distance to a destination each time the driver enters a main point, namely, crossroads of express high way and general road, for example, every a position spaced 3 km from the crossroads, while travelling route data. That is, a traffic situation of a road section can be continuously changed. Accordingly, the route guide unit 170 again selects route data each time a user enters a main set point, namely, a high way or a general road. Consequently, the driver can also receive provision of route data composed of a combination of road sections with the least compensation fuel consumption amount in a changed traffic situation.

The crossroads or main point is set by request of a driver through a separate key input unit (not shown) or according to a user's previous automatic research setting. Accordingly, the route guide unit 170 can again select (research) route data in set crossroads or main point by a request of the driver or a user's previous automatic research setting.

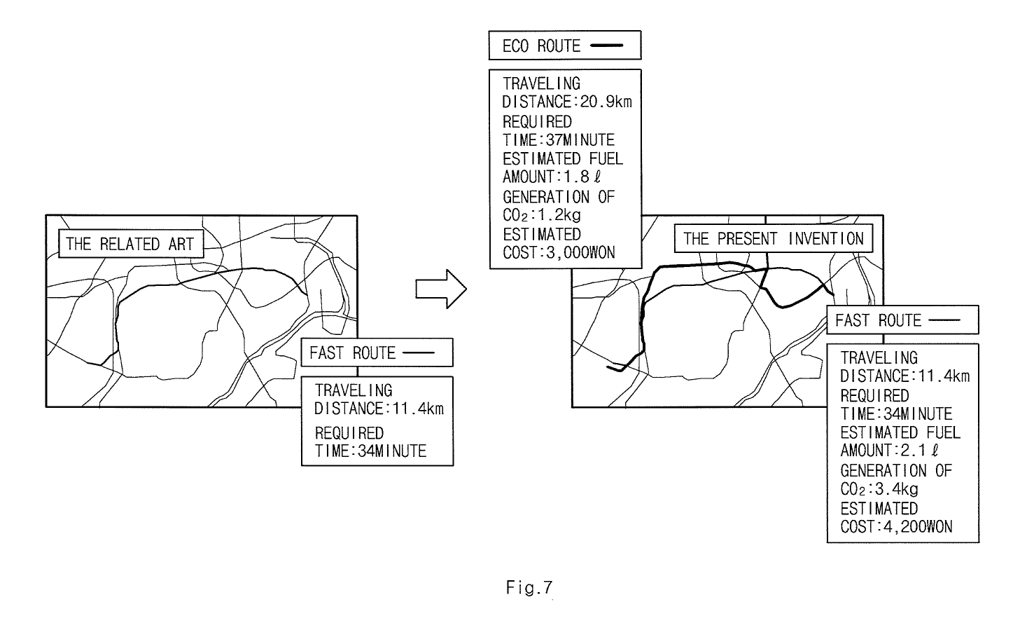

FIG. 7 is a view illustrating a captured screen of a fuel saving route displayed on a display unit according to an embodiment of the present invention.

The display unit 180 is configured by an LCD. The display unit 180 displays the calculated route data (including travel route, travel distance, required time, and expected cost) and a compensation fuel consumption amount according to the route data. Accordingly, the present invention can provide route data with a long travel distance to some degree as shown in FIG. 7 (left: the related art, right: the present invention) (fast route 11.4 km_{→}fuel saving route 20.9 km) but with small fuel consumption amount (fast route 2.1 l_{→}fuel saving route 1.8 l) to the driver.

—Operation of System for Calculating Fuel Amount of Travel Route—

Hereinafter, a method for calculating a fuel amount of a travel route according to the present invention will be described.

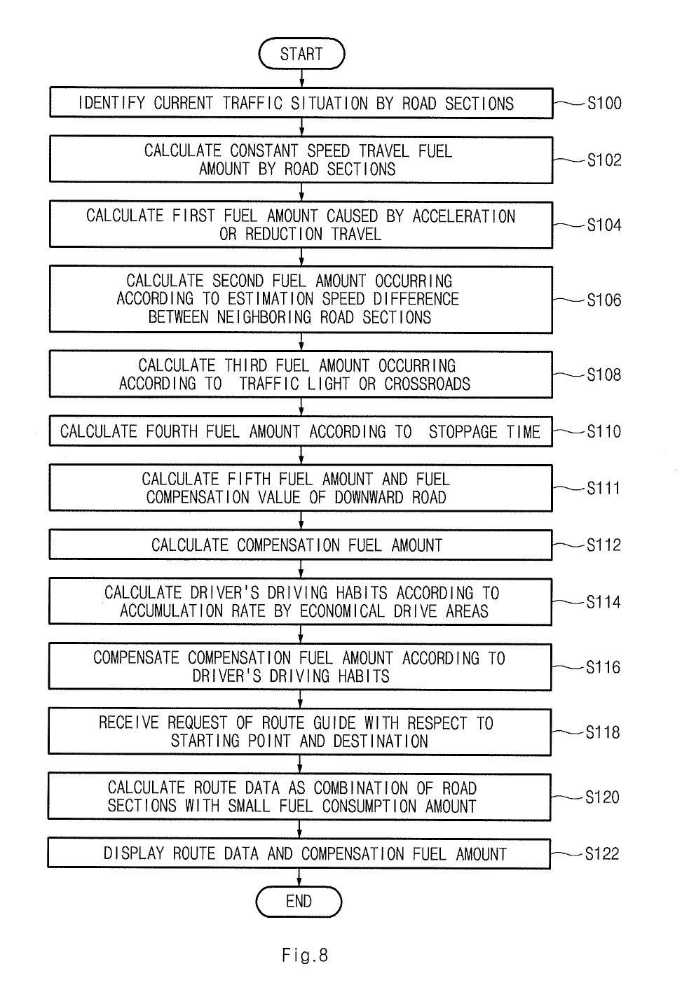

FIG. 8 is a flowchart illustrating a method for calculating a fuel amount of a traveling route according to an embodiment of the present invention.

Referring to FIG. 8, a traffic information collecting unit 110 identifies current traffic situation by road sections (S100).

Next, the fuel amount calculating unit 120 calculates a constant speed travel fuel amount consumed when a vehicle travels at constant speed by road sections in consideration of an estimated speed by road sections according to a current traffic situation (S102).

The fuel amount calculating unit 120 calculates a first fuel amount by road sections caused by acceleration or reduction travel occurring according to the estimated speed in respective road sections (S104).

A fuel amount compensating unit 130 calculates a second fuel amount according to acceleration or reduction travel occurring due to an estimated speed difference between neighboring road sections when the vehicle travels from a specific road section to another neighboring road section (S106).

The fuel amount compensating unit 130 calculates a third fuel amount caused by acceleration or reduction travel occurring according to a traffic light or crossroads provided at respective road sections (S108).

The fuel amount compensating unit 130 calculates a fourth fuel amount by road sections according to a stoppage time occurring according to an estimated speed (S110).

The fuel amount compensating unit 130 calculates a fifth fuel amount and a fuel compensation value of a downward road by road sections occurring according to an incline slope road or the decline slope road (S111).

The control unit 150 compensates for the first fuel amount to the fifth fuel amount of the fuel amount, and the fuel compensation value of a decline slope road to calculate a compensation fuel amount by road sections (S112).

A driving habit calculating unit 140 calculates economical drive areas using vehicle information, and calculates and transfers a driver's driving habits among the calculated economical drive areas according to an accumulation rate by economical drive areas to a control unit 150 (S114).

The control unit 150 compensates for the compensation fuel amount according to the driver's driving habits calculated by the driving habit calculating unit 140 (S116).

Next, a route guide unit 170 receives a request of a route guide with respect to a starting point and a destination from a driver (S118).

The route guide unit 170 calculates route data between the starting point and the destination as a combination of road sections with the least fuel consumption amount using map data (S120).

Next, the display unit 180 displays the route data calculated by the route guide unit 170 and a compensation fuel amount consumed according to the route data (S122).

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

In particular, it is apparent that the present invention is applicable to vehicles using electricity or hydrogen as a fuel as well as vehicles using oil as a fuel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for calculating a fuel amount of a travel route, comprising:
a traffic information collecting unit which identifies a traffic situation by road sections;
a fuel amount calculating unit which calculates a constant speed travel fuel amount consumed when a vehicle travels by the road sections at constant speed in consideration of an estimated speed according to the traffic situation by road sections;
a fuel amount compensating unit which calculates a first fuel amount by road sections according to acceleration or reduction travel caused by an estimated speed in respective road sections, and a second fuel amount according to acceleration or reduction travel caused by an estimated speed difference between neighboring road sections when the vehicle travels from a specific road section to a neighboring road section; and
a control unit which compensates for the first fuel amount and the second fuel amount in the constant speed travel fuel amount to calculate a compensation fuel amount by road sections.

2. The system of claim 1, wherein the fuel amount compensating unit further calculates a third fuel amount caused by acceleration or reduction travel, according to a traffic light or crossroads provided by road sections; and a fourth fuel amount by road sections caused by a stoppage time according to an estimated speed; and transfers the third and fourth fuel amounts to the control unit.

3. The system of claim 1, wherein the fuel amount compensating unit further calculates a fifth fuel amount according to an incline slope road provided by road sections and a fuel compensation value of a decline slope road occurring according to the inclined slope road provided by road sections, and transfers the fifth fuel amount and the fuel compensation value to the control unit.

4. The system of claim 1, further comprising a driving habit calculating unit which calculates a plurality of economical drive areas using vehicle information and a speed change pattern map, which calculates and transfers a driver's driving habits based on the plurality of economical drive areas according to an accumulation rate by economical drive areas to the control unit, so that the control unit compensates for the compensation fuel amount according to the driver's driving habits.

5. The system of claim 1, wherein the constant speed travel fuel amount is calculated by a following Equation:
Constant speed travel fuel amount=(travel resistance of a vehicle set according to estimated speed by road sections×travel distance by road sections)/(energy efficiency of the vehicle set according to the estimated speed by road sections);
the first fuel amount is calculated by a following Equation:
First fuel amount=(estimated acceleration set according to estimated speed of the road section×weight of the vehicle×estimated acceleration or reduction distance according to acceleration or reduction travel achieved in respective road sections)/(energy efficiency of the vehicle set according to estimated speed by road sections); and
the second fuel amount is calculated by a following Equation:
Second fuel amount=(estimated acceleration by road sections set according to estimated speed between neighboring road sections×weight of the vehicle×estimated acceleration or reduction distance according to acceleration or reduction travel occurring due to movement by road sections)/(energy efficiency of the vehicle set according to estimated speed by road sections).

6. The system of claim 2, wherein the third fuel amount is calculated by a following Equation:
Third fuel amount={(set acceleration×weight of the vehicle×accelerated distance until the vehicle reaches an estimated speed by road sections after stop according to the number of traffic lights or crossroads located in respective road section)/(energy efficiency of the vehicle set according to estimated speed by road sections)}×stagnation probability of the vehicle at a traffic light or crossroads(%); and
the fourth fuel amount is calculated by a following Equation:
Fourth fuel amount=(stoppage time set according to estimated speed by road sections×fuel consumption amount per stoppage time).

7. The system of claim 3, wherein the fifth fuel amount according to the incline slope road is calculated by a following Equation:
Fifth fuel amount=(weight of vehicle×gravity acceleration×sin(road gradient)×distance of decline slope road section)/(energy efficiency of vehicle set according to estimated speed by road sections); and
when an estimated speed by road sections in a decline slope road section by the road sections is greater than a minimum vehicle speed set in the decline slope road, the fuel compensation value of the decline slope road is calculated to process that there is no constant speed travel fuel amount in the decline slope road section.

8. The system of claim 1, further comprising:
a map database storing map data by road sections;
a route guide unit selecting route data comprising a combination of road sections with a least compensation fuel consumption amount between a starting point and a destination using the map data when receiving a request of a route guide with the starting point and the destination; and
a display unit displaying the selected route data and a compensation fuel amount consumed according to the route data.

9. The system of claim 8, wherein the route guide unit selects the route data composed of a combination of road sections with the least compensation fuel consumption amount between the starting point and the destination each time the vehicle enters a set crossroads during travel according to the route data.

10. The system of claim 8, wherein the route guide unit selects the route data composed of a combination of road sections with the least compensation fuel consumption amount between the starting point and the destination each time the vehicle enters a main set point during travel according to the route data.

11. A method for calculating a fuel amount of a travel route, comprising:
(a) identifying a traffic situation by road sections;
(b) calculating a constant speed travel fuel amount consumed when a vehicle travels by the road sections at constant speed in consideration of an estimated speed according to the traffic situation by road sections;
(c) calculating a first fuel amount by road sections caused by acceleration or reduction travel according to the estimated speed in respective road sections;
(c-1) calculating a second fuel amount caused by acceleration or reduction travel occurring due to an estimated speed difference between neighboring road sections when the vehicle travels from a specific road section to a neighboring road section; and
(d) compensating for the first fuel amount and the second fuel amount in the constant speed travel fuel amount to calculate a compensation fuel amount by road sections.

12. The method of claim 11, further comprising:
(e) calculating a third fuel amount caused by the acceleration or reduction travel according to a traffic light or crossroads provided by road sections; and
(f) calculating a fourth fuel amount by road sections according to a stoppage time according to an estimated speed.

13. The method of claim 11, further comprising:
(g) calculating a fifth fuel amount according to an incline slope road provided by road sections;
(h) calculating a fuel compensation value of a decline slope road according to the incline slope road provided by road sections.

14. The method of claim 11, further comprising:
(i) calculating a plurality of economical drive areas using vehicle information and a speed change pattern map; and
(j) calculating and transferring a driver's driving habits based on the plurality of economical drive areas according to an accumulation rate by economical drive areas to the control unit, so that the control unit compensates for the compensation fuel amount according to the driver's driving habits.

15. The method of claim 11, further comprising:
(k) selecting route data comprising a combination of road sections with a least compensation fuel consumption amount between a starting point and a destination using the map data when receiving a request of a route guide with the starting point and the destination; and
(l) displaying the selected route data and a compensation fuel amount consumed according to the route data.
